(19) United States
(12) Patent Application Publication
(10) Pub. No.: US 2016/0133200 A1
(43) Pub. Date: May 12, 2016

(54) DISPLAY DEVICE

(71) Applicant: Samsung Display Co., Ltd., Yongin-City (KR)

(72) Inventors: Tae Woo KIM, Seoul, (KR); Moongyu LEE, Suwon-si (KR); Byoungho CHEONG, Yongin-si (KR)

(21) Appl. No.: 14/680,256

(22) Filed: Apr. 7, 2015

(30) Foreign Application Priority Data
Nov. 10, 2014 (KR) 10-2014-0155586

(51) Int. Cl. G09G 3/34; G09G 3/36; G06K 9/00; G09G 3/20

(52) U.S. Cl. CPC G09G 3/3413; G09G 3/2003; G09G 3/3648; G09G 3/3688; G06K 9/00604; G09G 2300/0426; G09G 2320/0626; G09G 2360/14

(57) ABSTRACT

A display device includes a backlight unit generating a first light, a transparent light emitting sheet disposed on the backlight unit and including a light converting unit excited by the first light and generating a second light having a different wavelength from the first light, a display panel facing the backlight unit with the transparent light emitting sheet in-between and receiving the first and second lights, and a capturing unit provided between the transparent light emitting sheet and the backlight unit and capturing an image of a subject disposed on a front of the display panel.

### CLAIM OF PRIORITY

This U.S. non-provisional patent application claims priority under 35 U.S.C. §119 of Korean Patent Application No. 10-2014-0155586, filed on Nov. 10, 2014, the entire contents of which are hereby incorporated by reference.

### BACKGROUND OF THE INVENTION

The present invention relates to a display device enabling image viewing and eye contact capturing to be simultaneously performed.

Liquid crystal display devices are one of flat panel display devices and are used for displaying an image on various devices such as a TV, a monitor, a notebook, a mobile phone, and the like.

Liquid crystal display devices display an image by adjusting the intensity of an electric field applied to liquid crystals intervened between two substrates and adjusting an amount of light transmitting via the two substrates. A liquid crystal display device includes a liquid crystal display panel for displaying an image and a backlight unit for providing light to the liquid crystal display panel.

Furthermore, the liquid crystal display device may include a capturing unit capable of capturing an external image. Typically, the capturing unit is disposed so as not to be overlapped with a display part on which an image is displayed. Accordingly, when a user views an image being displayed on the display part, the viewing line of the user is not oriented toward the capturing unit. Accordingly, when the user views an image, the viewing line of the user in an image captured by the capturing unit is oriented toward a different direction from the front. In other words, the user is not able to perform the image viewing and eye contact capturing at the same time. On the contrary, when the user looks at the capturing unit for eye contact capturing, since the user is not able to view an image displayed on the display part, it is difficult to confirm his/her own appearance or opponent's appearance output through the display part.

### SUMMARY OF THE INVENTION

The present invention provides a display device enabling image viewing and eye contact capturing to be carried out at the same time.

Embodiments of the invention provide display devices including: a backlight unit generating a first light; a transparent light emitting sheet disposed on the backlight unit and including a light converting unit excited by the first light and generating a second light having a different wavelength from the first light; a display panel facing the backlight unit with the transparent light emitting sheet in-between and receiving the first and second lights; and a capturing unit provided between the transparent light emitting sheet and the backlight unit and capturing an image of a subject located at a front of the display panel.

In some embodiments, the transparent light emitting sheet may transmit a portion of the first light toward the display panel, and the light converting unit may be excited by another portion of the first light and converts the other portion of the first light into the second light.

In other embodiments, the transparent light emitting sheet may include a non-opening part and a plurality of opening parts.

In still other embodiments, an area of each of the plurality of opening parts may be in a range from about 100 nm² to about 100 μm².

In even other embodiments, transmittance of the non-opening part may be in a range of about 90% to 100%.

In yet other embodiments, the first and second lights may be mixed to generate a white light.

In further embodiments, the first light may be a blue light and the second light may be a yellow light.

In still further embodiments, the light converting unit may include a quantum point or a fluorescent body.

In even further embodiments, the display device may further include a controller generating a period control signal defining a capture period and a display period provided temporally alternately, wherein the backlight unit provides the first light during the display period, the display panel operates in a display state during the display period and in a transmitting state during the capture period, and the capturing unit captures an image of the subject during the capture period.

In yet further embodiments, the display panel may be driven by a gate signal and a data voltage in the display state so as to display an image, and may transmit the image of the subject disposed at the front of the display panel toward the capturing unit.

In much further embodiments, the display panel may include a display part displaying an image and a non-display part surrounding a display region, and the display part may include first and second parts, and the capturing unit may include a first sub-capturing unit provided in correspondence to the first part and a second sub-capturing unit provided in correspondence to the second part.

In still much further embodiments, the display device may further include a tracking unit comprising a viewing line detecting unit detecting the viewing line of a user and a viewing line determining unit generating a viewing signal including viewing information on a part viewed by the user between the first and second parts on the basis of the detected viewing line of the user, wherein the first and second sub-capturing units receive the viewing signal and are driven according to the viewing signal.

In even much further embodiments, the first sub-capturing unit may be driven in response to the viewing signal when the user views the first part, and the second sub-capturing unit may be driven in response to the viewing signal when the user views the second part.

In yet much further embodiments, the backlight unit may further include a diffusion plate disposed between the capturing unit and the backlight unit.

In yet still much further embodiments, the display device may further include an optical sheet between the capturing unit and the diffusion plate.

In yet even much further embodiments, the backlight unit may be disposed below the diffusion plate, may generate the first light, and may include at least one light source providing the first light toward the diffusion plate.

In still even further embodiments, the light guide plate may include an upper surface which faces the transparent light emitting sheet with the diffusion plate in-between and a side surface, and the at least one light source is disposed to face the side surface.

In still even much further embodiments, the light guide plate may face the transparent light emitting sheet with the diffusion plate in-between and the at least one light source may be disposed at one side of the light guide plate.

In still yet much further embodiments, the display device may further include a capture compensating unit compensating for the image of the subject captured by the capturing unit on the basis of preset transmission characteristic information on the transparent light emitting sheet.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is an exploded cross-sectional view of a display device according to an embodiment of the invention;

FIG. 2 is an equivalent circuit diagram of one pixel illustrated in FIG. 1;

FIG. 3 is an enlarged perspective view of a transparent light emitting sheet illustrated in FIG. 1;

FIG. 4 is a block diagram of the display device illustrated in FIG. 1;

FIG. 5 is a timing diagram representing operations of a display device in a display period and a capture period according to an embodiment of the invention;

FIG. 6A is a schematic diagram illustrating an operation in a display period of a display device according to an embodiment of the invention;

FIG. 6B is a schematic diagram illustrating an operation in a capture period of a display device according to an embodiment of the invention;

FIG. 7 is a view illustrating a user using a display device according to an embodiment of the invention;

FIG. 8 is a block diagram of a display device according to another embodiment of the invention;

FIG. 9 is a view illustrating a user using a display device illustrated in FIGS. 8; and

FIG. 10 is an exploded cross-sectional view of a display device according to still another embodiment of the invention.

### DETAILED DESCRIPTION OF THE INVENTION

The present invention may be variously modified and realized in various forms, and thus specific embodiments will be exemplified in the drawings and described in detail hereinbelow. However, the present invention is not limited to the specific disclosed forms, and needs to be construed to include all modifications, equivalents, or replacements included in the spirit and technical range of the present invention.

Like reference numerals refer to like elements throughout this specification. In the drawings, the dimensions of structures are exaggerated for clarity of illustration. It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of examplary embodiments. As used herein, the singular forms “a,” “an” and “the” are intended to include the plural forms as well unless the context clearly indicates otherwise.

It will be further understood that the terms “comprises”, “comprising,”, “includes” and/or “including”, when used herein, specify the presence of stated features, integers, steps, operations, elements, components or combinations thereof, but do not preclude the presence or addition of one or more other features, integers, steps, operations, elements, components, or combinations thereof. It will also be understood that, when a part such as a layer, a film, a region, or a plate, etc. is referred to as being ‘on’ another part, it can be “directly on” the other part, or an intervening part may also be present. On the contrary, it will be understood that, when a part such as a layer, a film, a region, or a plate, etc. is referred to as being ‘under’ another part, it can be “directly under”, or one or more intervening parts may also be present.

Hereinafter, specific embodiments will be described in detail with reference to the accompanying drawings.

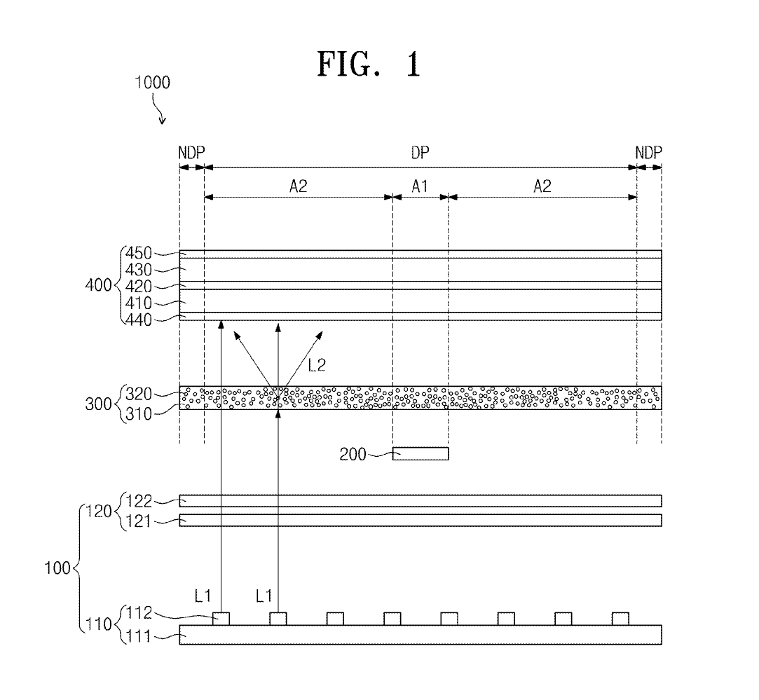

FIG. 1 is an exploded cross-sectional view of a display device according to an embodiment of the invention.

Referring to FIG. 1, a display device 1000 according to an embodiment of the invention includes a backlight unit 100, a capturing unit 200, a transparent light emitting sheet 300 and a display panel 400, which are sequentially disposed.

The backlight unit 100 includes a light source assembly 110 generating a first light L1, and an optical member 120 disposed between the light source assembly 110 and the capturing unit 200. As an example of an embodiment of the invention, the backlight unit 100 is a direct type.

The optical member 120 includes a diffusion plate 121 and an optical sheet 122.

The diffusion plate 121 is formed in a plate shape. The diffusion plate 121 is disposed on the optical source assembly 110, and may improve luminance uniformity by diffusing the first light L1 emitted from the light source assembly 110. In addition, the diffusion plate 121 may play a role of supporting the optical sheet 122 having thin thickness so as not to be drooped lower down.

The optical sheet 122 is disposed on the diffusion plate 121, and may be formed of at least one or more sheets for improving luminance characteristics of a light emitted from the diffusion plate 121. As an example, the optical sheet 122 may include one diffusion sheet for diffusing the light and two light collecting sheets for collecting the light.

The diffusion sheet is disposed on the diffusion plate 121 and diffuses a light emitted from the diffusion plate 121. The diffusion sheet may be formed of a transparent material, for example, a Polyethylene Terephthalate (PET) material.

The light collecting sheets are disposed on the top portion of the diffusion sheet and improve front luminance by collecting the light diffused through the diffusion sheet. The light collecting sheets respectively include a fine prism pattern having a prism shape. In particular, the light collecting sheets may respectively include prism patterns extended in different directions from each other.

The light source assembly 110 includes a light source driving substrate 111 and a plurality of light sources 112 connected to the light source driving substrate 111. The light sources 112 may be arrayed in a matrix type on the light source driving substrate 111.

As an embodiment of the invention, the light source driving substrate 111 may be provided in a plate shape. However, the light source driving substrate 111 is not limited thereto and may be provided in a rod shape extended in one direction. In this case, the light source driving substrate 111 of the rod shape may be provided in plurality, and the light sources 112 may be provided in a sequence along the one direction relative to the light source driving substrate 111.

Although not shown in the drawing, the backlight unit 100 may further include a reflection sheet. The reflection sheet reflects an incident light leaked to the lower portion of the light source assembly 110 toward the optical member 120 to improve light use efficiency. As an example, the reflection sheet may be formed from a PET or polycarbonate material.

The light sources 112 are mounted on the light source driving substrate 111 and are driven by the light source driving substrate 111. The light sources 112 provide the first light L1 toward the optical member 120.

The light sources 112 may be, for example, light emitting diodes (LEDs). As an example of the invention, the light sources 112 may be blue LEDs emitting blue lights. However, the light sources 112 are not limited thereto, and may be at least any one selected from a group consisting of red, green, cyan, magenta, and yellow LEDs respectively emitting red, green, cyan, magenta, and yellow lights, and combinations thereof.

The display panel 400 is formed of an array substrate 410, a counter substrate 430 facing the array substrate 410 and combined therewith, and a liquid crystal layer 420 intervened between the array substrate 410 and the counter substrate 430.

The counter substrate 430 may include a color filter for relaizing colors, a black matrix, and a common electrode formed of a transparent conductive material.

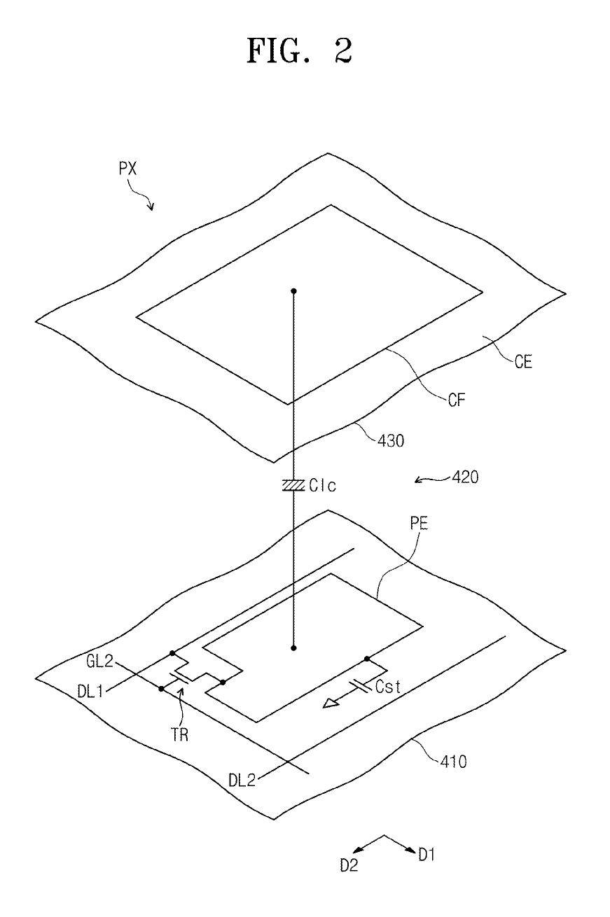

The display panel 400 includes a display part DP and a non-display part NDP. A plurality of pixels PX (shown in FIG. 2) are provided to the display part DP, and the display part DP displays an image through the pixels PX. The non-display part NDP is provided around the display part DP. Interconnections or a driving unit for driving the pixels PX may be provided to the non-display part NDP. The display panel 400 includes a first polarizing plate 440 attached on the bottom surface of the array substrate 410 and a second polarizing plate 450 attached to the top surface of the counter substrate 430.

The first and second polarizing plates 440 and 450, respectively, have first and second polarizing axes perpendicular to each other.

The transparent light emitting sheet 300 intervenes between the capturing unit 200 and the display panel 400. The transparent light emitting sheet 300 may be provided, for example, in a plate shape corresponding to the shape of the display panel 400.

The transparent light emitting sheet 300 includes a base 300 and a light converting unit 320. The base 310 is formed of a transparent polymer resin. For example, the base 310 is formed of the transparent polymer resin having transmittance in a range from about 90% to smaller than about 100%, and PET, polyethylene naphthalate (PEN), and polycarbonate (PC) and the like may also be used.

The light converting unit 320 may be dispersed in the base 310. However, it is not limited thereto, and a light converting layer (not illustrated) in which the light converting unit 320 is dispersed may be formed on the base 310. The light converting layer may be formed by dispersing the light converting unit 320 in a resin (not illustrated) having adhesion and by coating the resin including the dispersed light converting unit 320 therein on the base 310. The resin may include one or more of a silicon resin, an epoxy resin, and an acrylate resin.

The light converting unit 320 absorbs at least a part of the first light L1 to be excited. The excited light converting unit 320 may generate a second light L2 having a wavelength different from that of the first light L1. The second light L2 may be combined with the first light L1 to form a white light.

The second light L2 has a complementary color relationship with the first light L1. As described above, when the first light L1 is a blue color light, the second light L2 may be a yellow light. Accordingly, the first and second lights L1 and L2, respectively, may be combined to form a white light. The formed white light may be used as the backlight in the display panel 400.

The capturing unit 200 is intervened between the backlight unit 100 and the transparent light emitting sheet 300. In addition, the capturing unit 200 may be provided in correspondence to the display part DP. In other words, the capturing unit 200 may be provided in an overlapped manner with a region on which an image generated from the display panel 400 is displayed. In this case, a region at which the capturing unit 200 is provided may be defined as a first region A1 and a region at which the capturing unit 200 is not provided may be defined as a second region A2.

The capturing unit 200 may capture an image of a subject positioned in the front of the display panel 400. The capturing unit 200 is an optical element converting the image into an electrical signal and may include, for example, a charge coupled device (CCD).

FIG. 2 is an equivalent circuit diagram of one pixel illustrated in FIG. 1.

For convenience of explanation, a pixel PX connected to a second gate line GL2 and a first data line D1 is illustrated in FIG. 2. Although not illustrated in the drawing, configurations of other pixels PX of the display panel 400 may be substantially the same as that of the pixel PX illustrated in FIG. 2.

Referring to FIG. 2, the pixel PX includes a transistor TR connected to the second gate line GL2 and the first data line DL1, a liquid crystal capacitor Clc connected to the transistor TR and a storage capacitor Cst connected in parallel with the liquid crystal capacitor Clc. The storage capacitor Cst may be omitted.

The transistor TR may be disposed on the array substrate 410. The transistor TR includes a gate electrode connected to the second gate line GL2, a source electrode connected to the first data line DL1, and a drain electrode connected to the liquid crystal capacitor Clc and the storage capacitor Cst.

The liquid crystal capacitor Clc includes a pixel electrode PE disposed on the array substrate 410, a common electrode CE disposed on the counter substrate 430, and the liquid crystal layer 420 disposed between the pixel electrode PE and the common electrode CE. In this case, the liquid crystal layer 420 plays a role of a dielectric material. The pixel electrode PE is connected to the drain electrode of the transistor TR.

The common electrode CE may be entirely formed on the counter substrate 430. However, the common electrode CE is not limited thereto and may be disposed on the array substrate 410. In this case, at least one of the pixel electrode PE and the common electrode CE may include a slit.

The storage capacitor Cst may include the pixel electrode PE, a storage electrode (not illustrated) branched from a storage line (not illustrated), and an insulation layer disposed between the pixel electrode PE and storage electrodes. The storage line may be disposed on the array substrate 410 and simultaneously formed with the second gate line GL2 on the same layer. The storage electrode may be partially overlapped with the pixel electrode PE.

The pixel PX may further include the color filter CF representing one of the primary colors. As an exemplary embodiment, the color filter CF may be disposed on the counter substrate 430. However, the color filter CF is not limited thereto and may be disposed on the array substrate 410.

The transistor TR is turned on in response to a gate signal provided through the second gate line GL2. A data voltage received through the first data line DL1 is provided to the pixel electrode PE of the liquid crystal capacitor Clc through the turned on transistor TR. A common voltage is applied to the common electrode CE.

An electric field is formed between the pixel electrode PE and the common electrode CE by a level difference between the data voltage and the common voltage. Liquid crystal molecules of the liquid crystal layer 420 are driven by the electric field formed between the pixel electrode PE and the common electrode CE. Light transmittance is adjusted to display an image by means of the liquid crystal molecules driven by the formed electric field.

A storage voltage having a certain voltage level may be applied to the storage line. However, it is not limited thereto, and the storage line may receive the common voltage. The storage capacitor Cst plays a role of maintaining a voltage charged in the liquid crystal capacitor Clc.

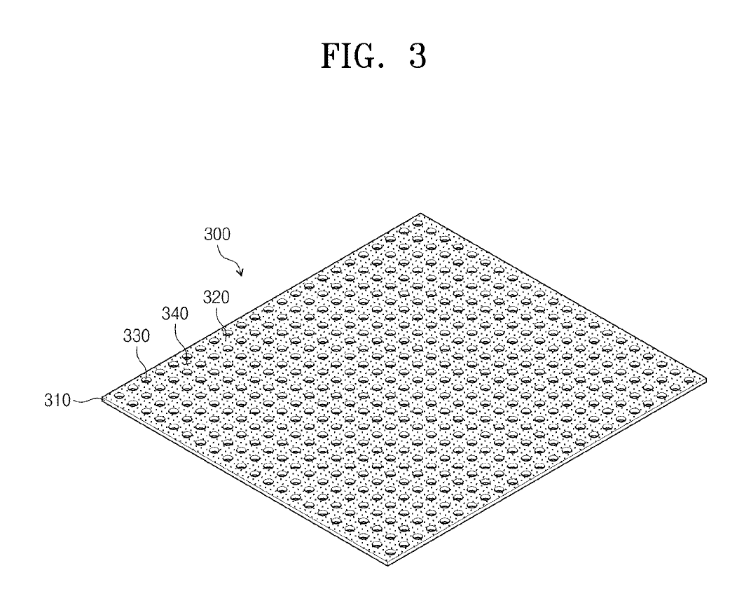

FIG. 3 is an enlarged perspective view of the transparent light emitting sheet illustrated in FIG. 1.

Referring to FIG. 3, the transparent light emitting sheet 300 includes a plurality of opening parts 330 and a non-opening part 340.

The plurality of opening parts 330 may be formed with the size of a micro unit. For example, the area of each of the plurality of opening parts 330 may be in a range of about 100 nm² to about 100 μm². The opening parts 310 may be arrayed in, for example, a matrix type. The pitch of the opening parts 330 may be in a range of several nm to several hundreds μm. The size and pitch of the opening parts 330 may be experimentally determined to minimize haze of the transparent light emitting sheet 300 and to maximize transmittance of the transparent light emitting sheet 300.

The first light L1 provided toward the opening parts 330 from the backlight unit 100 may be transmitted without reduction of luminance. Accordingly, the opening parts 330 improve transmittance of the transparent light emitting sheet 300. Accordingly, the transmittance of the transparent light emitting sheet 300 may be greater than that of the transparent polymer resin included in the base 310.

In addition, since the base 310 is formed of the transparent polymer resin, the transmittance of the non-opening part 340 itself may be in a range from about 90% to not greater than about 100%. Accordingly, a part of the first light L1 provided toward the non-opening part 340 from the backlight unit 100 may transmit through the non-opening parts 340. Furthermore, as described above, another part of the first light L1 is absorbed by the light converting unit 320 dispersed in the base 310 of the non-opening part 340 and excites the light converting unit 320.

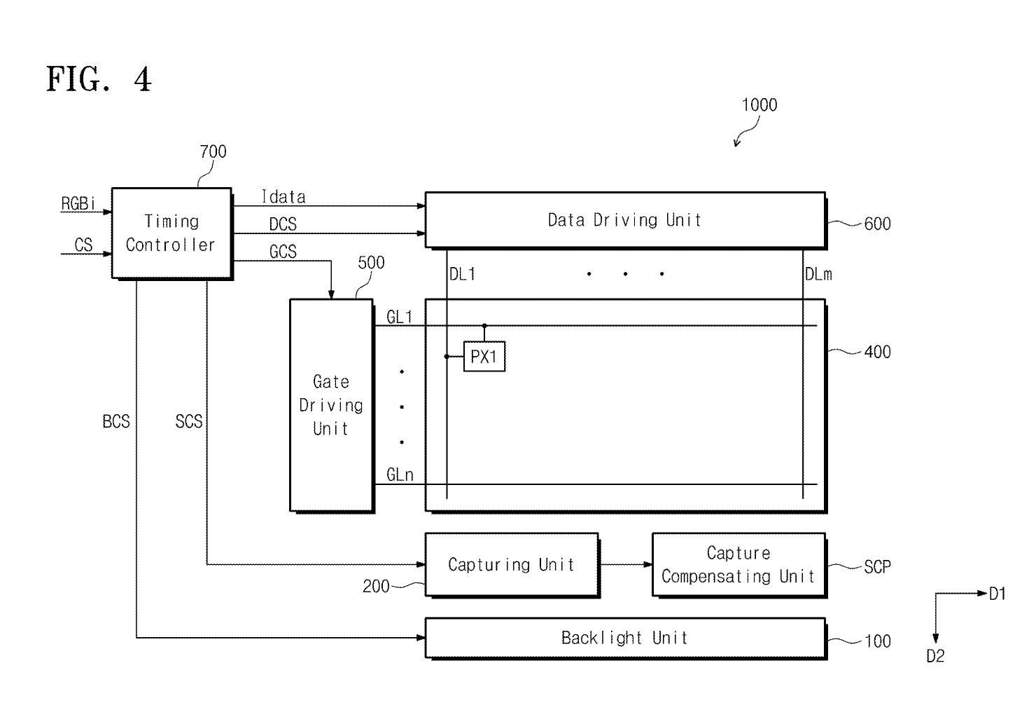

FIG. 4 is a block diagram of the display device illustrated in FIG. 1.

Referring to FIG. 4, the display device 1000 includes a gate driving unit 500 and a data driving unit 600 driving the display panel 400, and a timing controller 700 controlling the driving of the gate driving unit 500 and the data driving unit 600.

The timing controller 700 receives input image information RGBi and a plurality of control signals CS from the outside of the display device 1000. The timing controller 700 converts a data format of the input image information RGBi to create output image data Idata so as to be matched with an interface of the data driving unit 600 and the specification of the display panel 400, and provides the output image data Idata to the data driving unit 600.

In addition, the timing controller 700 creates data control signals DCS (for example, an output start signal, a horizontal start signal and the like) and gate control signals GCS (for example, a vertical start signal, a vertical clock signal, a vertical clock bar signal and the like) based on the plurality of control signals CS. The data control signals DCS are provided to the data driving unit 600 and the gate control signals GCS are provided to the gate driving unit 500.

The gate driving unit 500 sequentially outputs gate signals in response to the gate control signals GCS provided by the timing controller 700.

The data driving unit 600 converts the output image data Idata into data voltages so as to output the data voltages to the display panel 400 in response to the data control signals DCS provided by the timing controller 700.

The display panel 400 further comprises a plurality of gate lines GL1 to GLn and a plurality of data lines DL1 to DLm.

The pixels PX are devices displaying a basic unit image forming an image and the resolution of the display panel 400 may be determined according to the number of the pixels PX included in the display panel 400. Only one pixel PX is illustrated in FIG. 1 and illustrations of other pixels are omitted.

Each pixel PX may display one of primary colors. The primary colors may include red, green, blue, and white. However, the primary colors are not limited thereto and may further include various colors such as yellow, cyan, and magenta, and the like.

The plurality of gate lines GL1 to GLn are extended in a first direction D1 and are arrayed in parallel in a second direction D2 which is perpendicular to the first direction D1. The plurality of gate lines GL1 to GLn are connected to the gate driving unit 500 and sequentially receive the gate signals from the gate driving unit 500. As an example of the invention, the gate signals may be sequentially provided to the gate lines GL1 to GLn along the second direction D2.

The plurality of data lines DL1 to DLm are extended in the second direction D2 and are arrayed in parallel in the first direction D1. The plurality of data lines DL1 to DLm are connected to the data driving unit 600 and receive the data voltages from the data driving unit 600.

The pixels PX may be connected to corresponding gate lines among the gate lines GL1 to GLn and corresponding data lines among the data lines DL1 to DLm. In detail, the pixels PX may be turned on or tuned off by the applied gate signals. The turned on pixels PX display gradations corresponding to the applied data voltages.

A polarity of a data voltage applied to each of the pixels PX may be reversed for each frame in order to prevent degradation of the liquid crystals included in the display panel 400. For example, the data driving unit 600 may revert and output the polarities of the data voltages for each frame in response to a reversal signal (not illustrated) included in the data control signals DCS. In addition, when an image of one frame is displayed, data voltages having different polarities are outputted for every two data lines and are provided to the pixels PX for improving display quality.

The timing controller 700 may be mounted on a printed circuit board in an integrated circuit chip type arrangement and may be connected to the gate driving unit 500 and the data driving unit 600. The gate and data driving units 500 and 600, respectively, may be formed of a plurality of driving chips to be mounted on a flexible printed circuit board, and may be connected to the display panel 400 in a tape carrier package (TCP) scheme.

However, the gate and data driving units 500 and 600, respectively, are not limited thereto and may be formed of a plurality of driving chips to be mounted on the display panel 400 in a chip on glass (COG) scheme. Furthermore, the gate driving unit 500 may be formed simultaneously with transistors of the pixels PX and may be mounted on the display panel in an amorphous silicon TFT gate driver circuit (ASG) type.

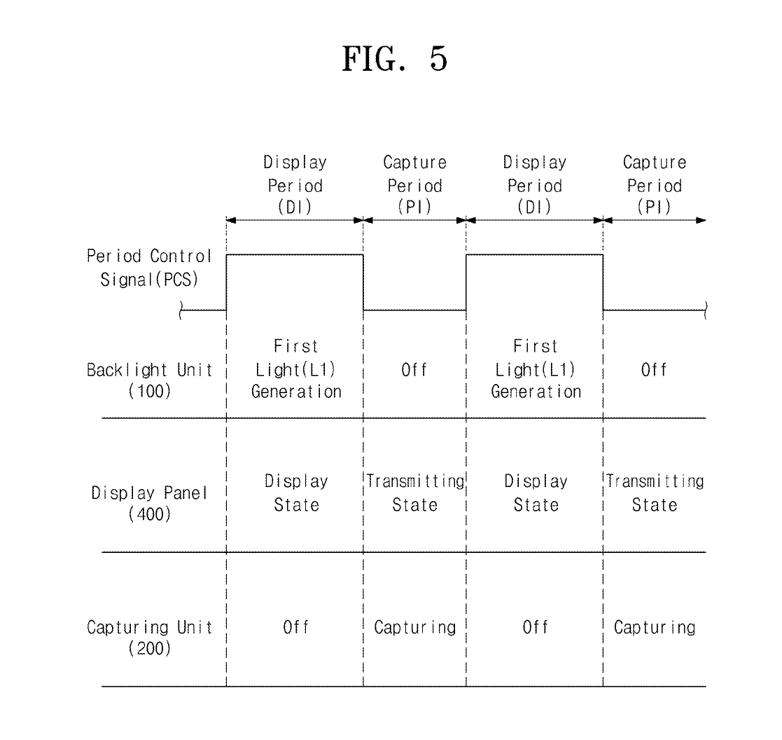

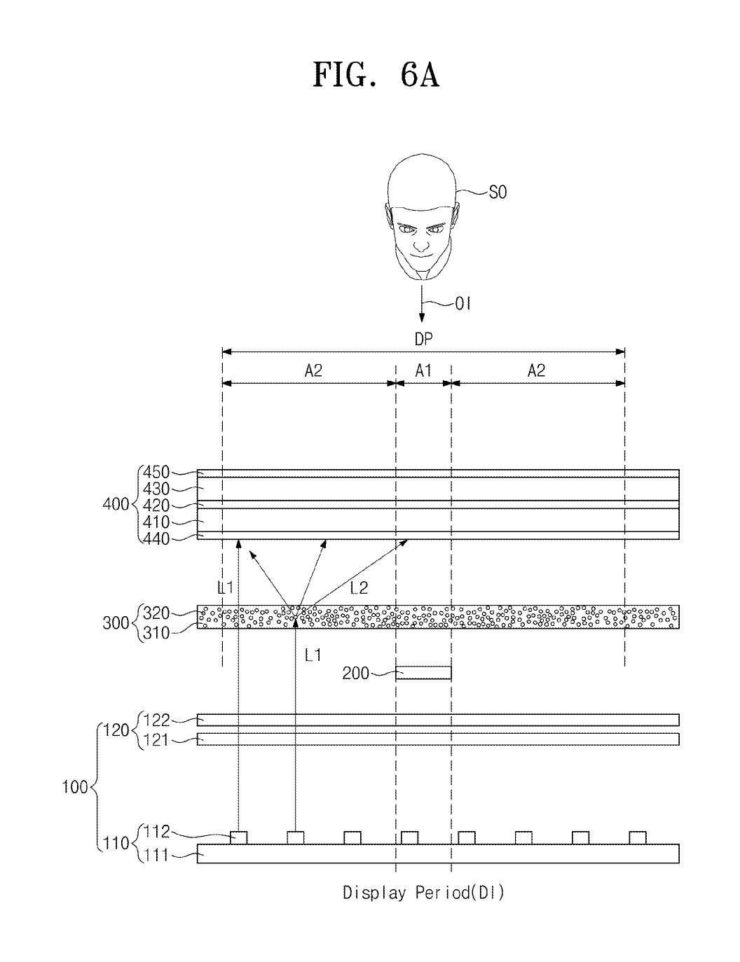

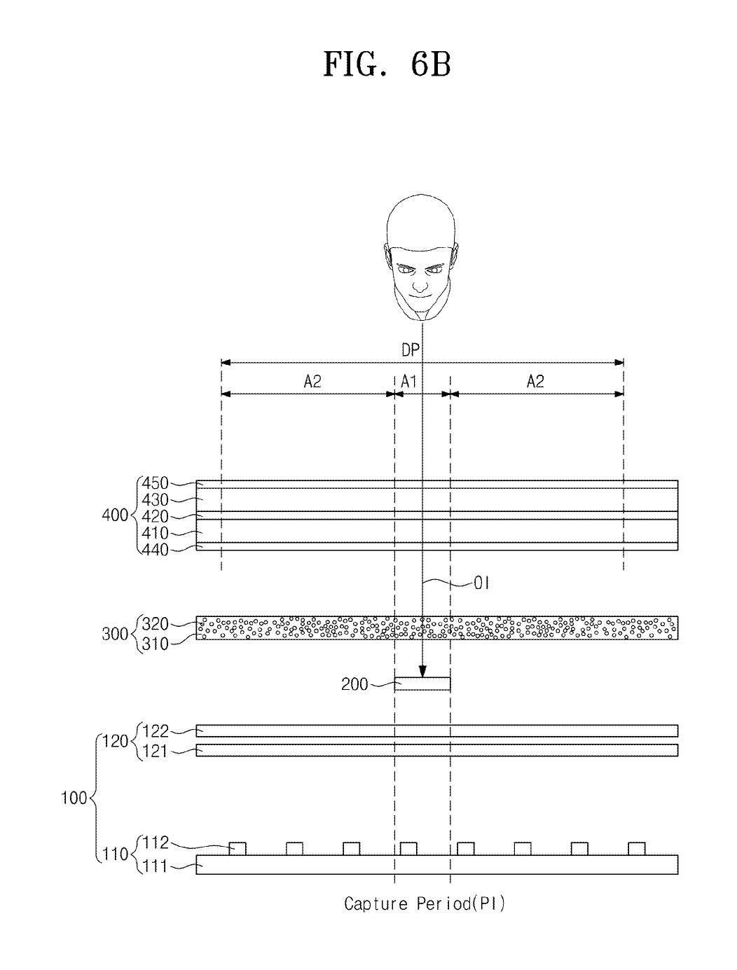

FIG. 5 is a timing diagram representing operations of the display device in a display period and a capture period according to an embodiment of the invention, FIG. 6A is a schematic diagram illustrating operations of the display device in the display period according to an embodiment of the invention, and FIG. 6B is a schematic diagram illustrating the operation of the display device in the capture period according to an embodiment of the invention.

Hereinafter, a description is provided relative to an operation of the display device 1000 with further reference to FIGS. 5, 6A and 6B.

A period control signal PCS illustrated in FIG. 5 may be created by the timing controller 700 (illustrated in FIG. 4). The period control signal PCS defines the display period DI and the capture period PI provided in a temporally alternating manner. The period control signal PCS may have, for example, a high level in the display period DI and a low level in the capture period PI.

The timing controller 700 creates a backlight control signal BCS based on the period control signal PCS and outputs the backlight control signal BCS to the backlight unit 100. The backlight unit 100 creates the first light L1 in response to the backlight control signal BCS.

Furthermore, the timing controller 700 creates a capture control signal SCS based on the period control signal PCS and outputs the capture control signal SCS to the capturing unit 200. The capturing unit 200 captures an image in response to the capture control signal SCS.

The timing controller 700 synchronizes an image capture timing of the capturing unit 200 with an image output timing of the display panel 400 so that image capturing of the capturing unit 200 and image output of the display panel 400 are carried out alternately.

In detail, as illustrated in FIG. 6A, the light sources 112 of the backlight unit 100 generate the first light L1 in the display period DI. The first light L1 generated by the backlight unit 100 is incident to the optical member 120. Then, the first light L1 is diffused by the optical member 120 so as to reach the transparent light emitting sheet 300.

A part of the first light L1 arriving at the transparent light emitting sheet 300 transmits through the transparent light emitting sheet 300 to reach the display panel 400. Another part of the first light L1 is converted to the second light L2 by the light converting unit 320 of the transparent light emitting sheet 300.

The light converting unit 320 may be, for example, any one of a quantum dot or a fluorescent body. In this case, the second light L2 into which the light converting unit 320 converts may be diffused so as to be provided to the display panel 400.

The display panel 400 operates in a display state in the display period DI. When the display panel 400 operates in the display state, the display panel 400 receives a data voltage from the data driving unit 600 and outputs an image corresponding to the output image data Idata.

The display panel 400 may display an image corresponding to one frame during the display period DI. However, the display panel 400 is not limited thereto, and may consecutively display images corresponding to two or more frames during the display period DI.

Furthermore, the first and second lights L1 and L2, respectively, may be reflected by the transparent light emitting sheet 300 and the display panel 400 so as to be incident to the capturing unit 200. In this case, an image OI (see FIG. 6B) of a subject captured by the capturing unit 200 may be distorted. Accordingly, the capturing unit 200 may become Off in the display period DI.

Referring to FIG. 6B, the backlight unit 100 becomes Off and the backlight unit 100 does not generate the first light L1 in the capture period PI. Accordingly, the transparent light emitting sheet 300 does not generate the second light L2, neither.

In addition, the display panel 400 operates in a transmitting state in the capture period PI. When the display panel 400 operates in the transmitting state, the display panel 400 is driven so that a light incident on one surface of the display panel 400 may pass through the display panel 400. For example, data voltages corresponding to white gradation (255 gradations) are provided to all of the pixels PX (illustrated in FIG. 4) of the display panel 400. Accordingly, when the display panel 400 operates in the transmitting state, the image OI of a subject disposed in front of the display panel 400 may pass through the display panel 400 so as to reach the transparent light emitting sheet 300 and the capture unit 200.

Furthermore, the capturing unit 200 may capture the image OI of the subject, which transmits through the display panel 400 and the transparent light emitting sheet 300 so as to arrive.

In such a way, the image capturing of the capturing unit 200 and image output of the display panel 400 are carried out alternately. The capturing unit 200 captures an image while an image is not outputted from the display panel 400, and the display panel 400 outputs an image while the capturing unit 200 does not capture. According to such an operation, the capturing unit 200 may capture the image OI of the subject without interference of an image output from the display panel 400.

Furthermore, since the capturing unit 200 is provided at the lower side of the transparent light emitting sheet 300, the first light L1 provided to the first region A1 may be covered. As the result, a luminance difference may occur between images displayed on the first region A1 and the second region A2, or a dark space corresponding to the first region A1 may be formed.

Like an embodiment of the invention, since the light converting unit 320 of the transparent light emitting sheet 300 may include a quantum point or a fluorescent body, the second light L2 generated by excitation of the light converting unit 320, including the quantum point or the fluorescent body, may be provided to the first region A1, as illustrated FIG. 6A. Accordingly, the luminance difference or the dark space may be prevented from occurring.

Referring to FIG. 4 again, as an example of the invention, the display device 1000 may further include a capture compensating unit SCP. The capture compensating unit SCP receives the captured image OI of the subject from the capturing unit 200 and compensates for the image OI of the subject.

In detail, the capture compensating unit SCP may compensate for the subject image OI varied according to the transmission characteristic by passing through the transparent light emitting sheet 300 on the basis of transmission characteristic information of the transparent light emitting sheet 300. The transmission characteristic of the transparent light emitting sheet 300 may include transmittance for each wavelength of the transparent light emitting sheet 300 and haze of the transparent light emitting sheet 300. The transmission characteristic of the transparent light emitting sheet 300 may be preset experimentally and stored in a memory (not illustrated) included in the display device 1000 or the capture compensating unit SCP.

For example, when a first transmittance in a region corresponding to a yellow wavelength of the transparent light emitting sheet 300 is higher than a second transmittance in other regions, the capturing unit 200 may capture the subject image OI having more yellow component than the original one. In this case, the capture compensating unit SCP may correct the subject image OI on the basis of the first and second transmittances to recover the original image

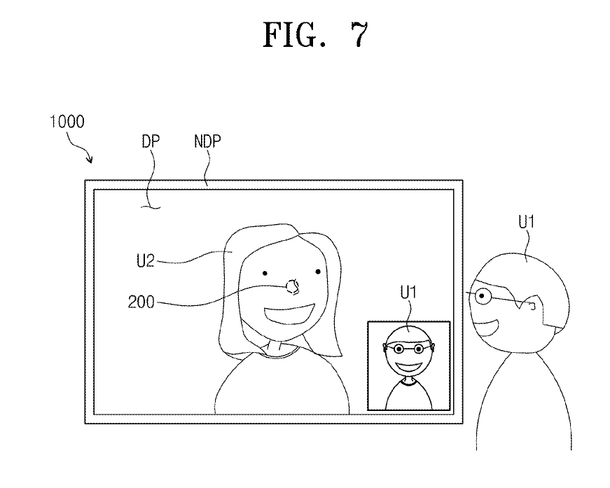

FIG. 7 is a view illustrating a user using a display device according to an embodiment of the invention.

Referring to FIG. 7, a first user U1 makes a video call with a second user U2 through the display device 1000. The first user U1 may make a video call while watching the capturing unit 200 included in the display part DP. Accordingly, the first user U1 may view a figure of the second user U2 displayed on the display device 1000. Since eye contact capturing is possible at the same time, the viewing line of the first user U1 may face the front on the image of the first user U1 captured by the capturing unit 200.

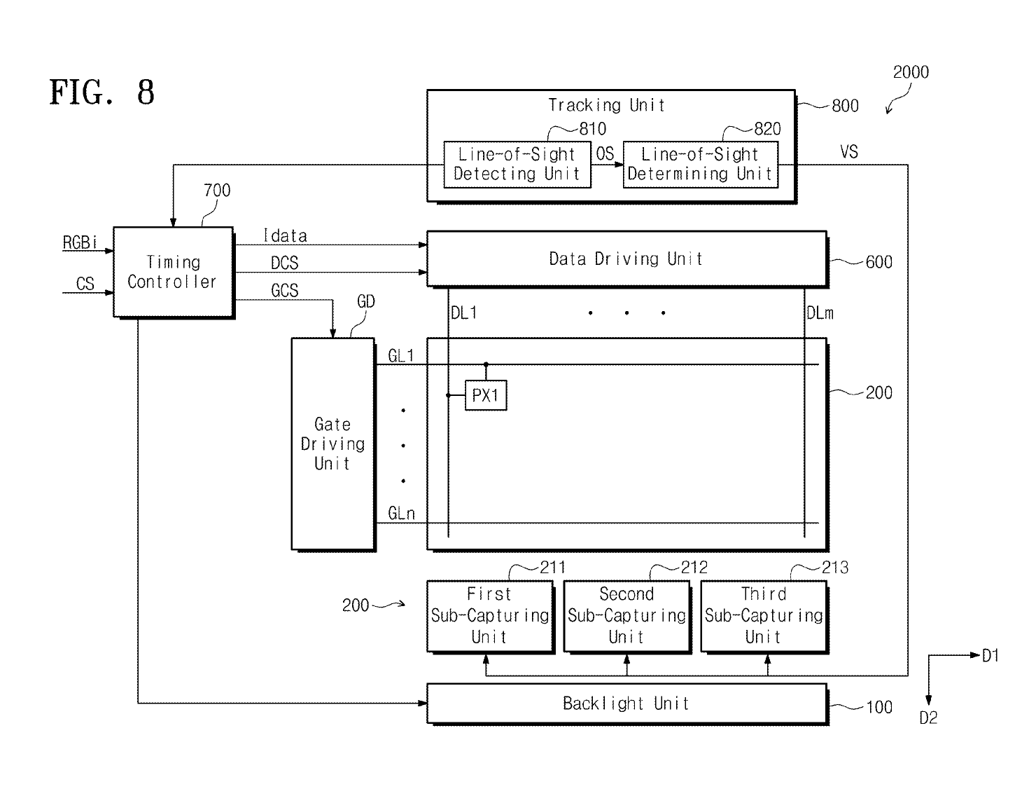

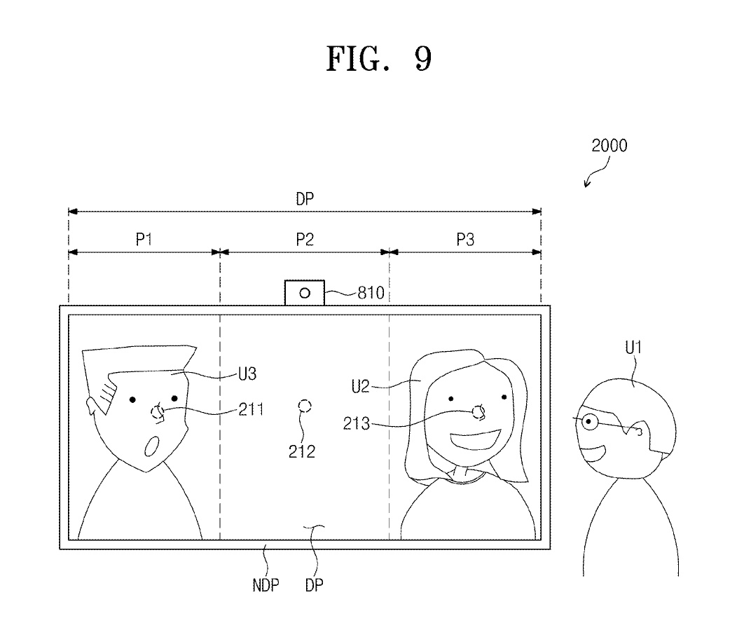

FIG. 8 is a block diagram of a display device according to another embodiment of the invention, and FIG. 9 is a view of a user using the display device illustrated in FIG. 8.

Referring to FIGS. 8 and 9, the illustrated display device 2000 further includes a tracking unit 800 and is the same as the display device 1000 except that the capturing unit 200 includes first to third sub-capturing units 211 to 213. Therefore, overlapping descriptions are omitted.

As an example of the invention, the display part DP of the display panel 400 may be divided into first to third parts P1 to P3. The first to third parts P1 to P3 may respectively correspond to three parts into which the display part DP is divided along a lateral direction. In this case, the first to third sub-capturing units 211 to 213 may be provided in correspondence to a central part of the first to third parts P1 to P3.

The capturing unit 200 is not limited thereto and may be provided in various manners. For example, the capturing unit 200 may include four or more sub-capturing units and the sub-capturing units may be provided in a matrix type relative to the display part DP.

The tracking unit 800 may include a viewing line or line-of-sight detecting unit 810 and a viewing line or line-of-sight determining unit 820.

The viewing line detecting unit 810 may detect the viewing line of the first user U1. The viewing line detecting unit 810 generates a viewing line signal OS having information on the detected viewing line.

The viewing line determining unit 820 receives the viewing line signal OS, determines the viewing line of the first user U1 based on the viewing line signal, and generates a viewing signal VS. The viewing signal VS includes information on a part (hereinafter, a viewed part) viewed by the first user U1 among the first to third parts P1 to P3.

The first to third sub-capturing units 211 to 213 receive the viewing signal VS and are driven according to viewing line information in the viewing signal VS. In detail, the first sub-capturing unit 211 captures the first user U1 in response to the viewing signal VS, when the first user U1 views the first part P1. In this case, the second and third sub-capturing units 212 and 213 may not capture the first user U1.

Similarly, the second sub-capturing unit 212 captures the first user U1 in response to the viewing signal VS, when the first user U1 views the second part P2. In this case, the first and third sub-capturing units 211 and 213, respectively, may not capture the first user U1.

In addition, the third sub-capturing unit 213 captures the first user U1 in response to the viewing signal VS, when the first user U1 views the third part P3. In this case, the first and second sub-capturing units 211 and 212, respectively, may not capture the first user U1.

For example, when the first user U1 views an image of the third user U3 displayed on the first part P1, the first sub-capturing unit 211 captures an image of the first user U1. Furthermore, when the first user U1 views an image of the second user U2, the third sub-capturing unit 213 may capture an image of the first user U1.

When the size of the display part DP is large, the viewing line of the first user U1 may be varied according to which part of an image displayed on the display part DP the first user U1 views.

In such a way, the first user U1 may simultaneously view and eye-contact-capture an image displayed on the display device 1000 by providing the first to third sub-capturing units 211 to 213 to the display part DP and driving the first to third capturing units 211 to 213 according to the viewing line of the first user U1.

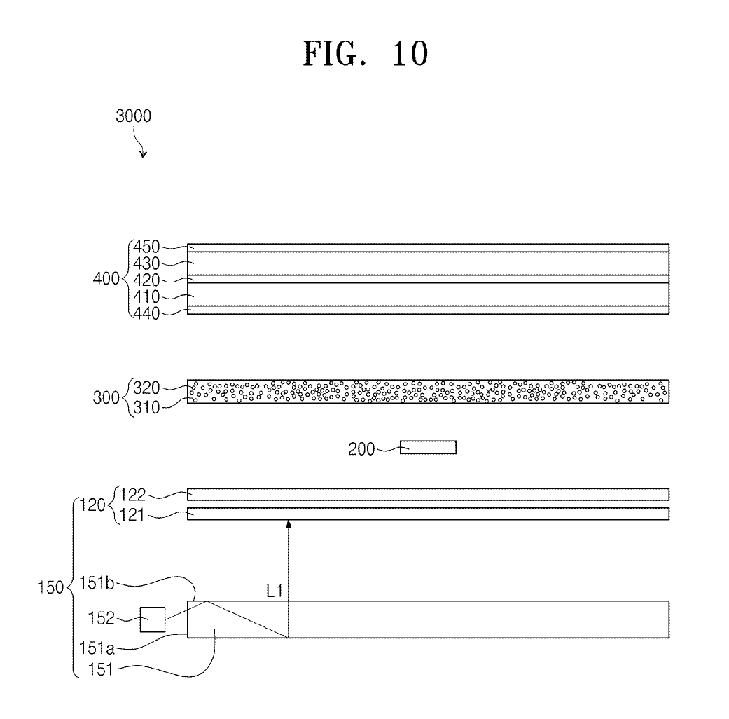

FIG. 10 is an exploded cross-sectional view of a display device according to still another embodiment of the invention.

Since a display device 3000 illustrated in FIG. 10 is the same as the display device 1000 illustrated in FIG. 1 except that the display device 3000 includes an edge type backlight unit 150, overlapping descriptions are omitted.

Referring to FIG. 10, the backlight unit 150 includes a light guide plate 151 and at least one light source 152. The light guide plate 151 faces the transparent light emitting sheet 300 with the diffusion plate 121 in-between, and includes a light input surface 151a facing the light source 152 and a light output surface 151b facing the diffusion plate 121.

The light source 152 is disposed at one side of the light guide plate 151. The light source 152 generates the first light L1 and provides the first light L1 to the light input surface 151a. The light guide plate 151 receives the first light L1, guides the first light L1, and provides the first light L1 toward the diffusion plate 121 through the light output surface 15lb.

According to embodiments of the invention, since a capturing unit is intervened between a transparent light emitting sheet and a backlight unit, occurrence of a dark space on a display part is prevented, and distortion of an image captured by the capturing unit can be improved.

The above-disclosed subject matter is to be considered illustrative and not restrictive, and the appended claims are intended to cover all such modifications, enhancements, and other embodiments, which fall within the true spirit and scope of the invention. Thus, to the maximum extent allowed by law, the scope of the invention is to be determined by the broadest permissible interpretation of the following claims and their equivalents, and shall not be restricted or limited by the foregoing detailed description.

What is claimed is:

1. A display device, comprising:
a backlight unit generating a first light;
a transparent light emitting sheet disposed on the backlight unit and including a light converting unit excited by the first light and generating a second light having a different wavelength from the first light;
a display panel facing the backlight unit with the transparent light emitting sheet in-between and receiving the first and second lights; and
a capturing unit provided between the transparent light emitting sheet and the backlight unit and capturing an image of a subject located at a front of the display panel.

2. The display device of claim 1, wherein the transparent light emitting sheet transmits a portion of the first light toward the display panel; and
wherein the light converting unit is excited by another portion of the first light and converts said another portion of the first light into the second light.

3. The display device of claim 2, wherein the transparent light emitting sheet comprises a non-opening part and a plurality of opening parts.

4. The display device of claim 3, wherein an area of each of the plurality of opening parts is in a range of about 100 nm² to about 100 μm².

5. The display device of claim 4, wherein transmittance of the non-opening part is in a range of about 90% to 100%.

6. The display device of claim 1, wherein the first and second lights are mixed to generate a white light.

7. The display device of claim 6, wherein the first light is a blue light and the second light is a yellow light.

8. The display device of claim 1, wherein the light converting unit includes at least one of a quantum point and a fluorescent body.

9. The display device of claim 1, further comprising a controller generating a period control signal defining a capture period and a display period provided temporally alternately;
wherein the backlight unit provides the first light during the display period;
wherein the display panel operates in a display state during the display period and in a transmitting state during the capture period; and
wherein the capturing unit captures an image of the subject during the capture period.

10. The display device of claim 9, wherein the display panel is driven by a gate signal and a data voltage in the display state to display an image, and transmits the image of the subject disposed at the front of the display panel toward the capturing unit.

11. The display device of claim 1, wherein the display panel includes a display part displaying an image and a non-display part surrounding a display region, and the display part includes first and second parts; and
wherein the capturing unit includes a first sub-capturing unit provided in correspondence to the first part and a second sub-capturing unit provided in correspondence to the second part.

12. The display device of claim 1, further comprising a tracking unit including a viewing line detecting unit detecting the viewing line of a user and a viewing line determining unit generating a viewing signal including viewing information on a part viewed by the user between the first and second parts on the basis of the detected viewing line of the user;
wherein the first and second sub-capturing units receive the viewing signal and are driven according to the viewing signal.

13. The display device of claim 12, wherein the first sub-capturing unit is driven in response to the viewing signal when the user views the first part, and the second sub-capturing unit is driven in response to the viewing signal when the user views the second part.

14. The display device of claim 1, wherein the backlight unit further comprises a diffusion plate disposed between the capturing unit and the backlight unit.

15. The display device of claim 14, further comprising an optical sheet between the capturing unit and the diffusion plate.

16. The display device of claim 14, wherein the backlight unit is disposed below the diffusion plate, generates the first light, and includes at least one light source providing the first light toward the diffusion plate.

17. The display device of claim 14, wherein the backlight unit includes at least one light source generating the first light and a light guide plate receiving the first light and guiding the first light to provide the first light to the diffusion plate.

18. The display device of claim 17, wherein the light guide plate includes an upper surface which faces the transparent light emitting sheet with the diffusion plate in-between and a side surface, and the at least one light source is disposed to face the side surface.

19. The display device of claim 1, further comprising a capture compensating unit compensating for the image of the subject captured by the capturing unit on the basis of predetermined transmission characteristic information on the transparent light emitting sheet.
